(19) United States
(12) Patent Application Publication
(10) Pub. No.: US 2014/0233361 A1
(43) Pub. Date: Aug. 21, 2014

(54) THERMALLY-ASSISTED MAGNETIC RECORDING HEAD AND METHOD OF MANUFACTURING THE SAME

(71) Applicant: TDK CORPORATION, Tokyo (JP)

(72) Inventor: Koji SHIMAZAWA, Tokyo (JP)

(73) Assignee: TDK CORPORATION, Tokyo (JP)

(21) Appl. No.: 13/772,936

(22) Filed: Feb. 21, 2013

(51) Int. Cl. G11B 13/04; G11B 5/127

(52) U.S. Cl. CPC G11B 13/04; G11B 5/1272
USPC 369/13.32; 29/603.16

(57) ABSTRACT

This thermally-assisted magnetic recording head includes: a waveguide; a magnetic pole; and a plasmon generator having a first region and a second region, in which the first region has an one end exposed on an air-bearing surface and another end located on an opposite side of the air-bearing surface, and in which the second region is coupled to the another end of the first region and has a volume greater than a volume of the first region. The first region includes a high-density region having a density that is greater than the density of the second region.

### BACKGROUND OF THE INVENTION

1. Field of the Invention

The invention relates to a thermally-assisted magnetic recording head used in thermally-assisted magnetic recording in which near-field light is applied to lower a coercivity of a magnetic recording medium so as to perform recording of information, and to a method of manufacturing the thermally-assisted magnetic recording head.

2. Description of Related Art

A magnetic disk unit has been used for writing and reading magnetic information (hereinafter, simply referred to as information). The magnetic disk unit includes, in a housing thereof for example, a magnetic disk in which information is stored, and a magnetic recording reproducing head that records information into the magnetic disk and reproduces information stored in the magnetic disk. The magnetic disk is supported by a rotary shaft of a spindle motor, which is fixed to the housing, and rotates around the rotary shaft. On the other hand, the magnetic recording reproducing head is formed on a side surface of a magnetic head slider provided on one end of a suspension, and includes a magnetic recording element and a magnetic reproducing element that have an air bearing surface (ABS) facing the magnetic disk. In particular, an MR element exhibiting magnetoresistive (MR) effect is generally used as the magnetic reproducing element. The other end of the suspension is attached to an end of an arm pivotally supported by a fixed shaft installed upright in the housing.

When the magnetic disk unit is in a stationary state, namely, when the magnetic disk does not rotate and remains stationary, the magnetic recording reproducing head is not located over the magnetic disk and is pulled off to the outside (unload state). When the magnetic disk unit is in a driven state and the magnetic disk starts to rotate, the magnetic recording reproducing head is changed to a state where the magnetic recording reproducing head is moved to a predetermined position over the magnetic disk together with the suspension (load state). When the number of rotation of the magnetic disk reaches a predetermined number, the magnetic head slider is stabilized in a state of slightly floating over the surface of the magnetic disk due to the balance of positive pressure and negative pressure. Thus, information is accurately recorded and reproduced.

In recent years, along with a progress in higher recording density (higher capacity) of the magnetic disk, improvement in performance of the magnetic recording reproducing head and the magnetic disk has been demanded. The magnetic disk is a discontinuous medium including collected magnetic microparticles, and each magnetic microparticle has a single-domain structure. In the magnetic disk, one recording bit is configured of a plurality of magnetic microparticles. Since the asperity of a boundary between adjacent recording bits needs to be made small in order to increase the recording density, it is necessary to reduce a size of the magnetic microparticles. However, when the magnetic microparticles are made small in size, thermal stability of the magnetization of the magnetic microparticles is disadvantageously lowered with decreasing volume of the magnetic microparticles. To solve this issue, it is effective to increase anisotropy energy of the magnetic microparticle. However, increasing the anisotropy energy of the magnetic microparticle leads to increase in the coercivity of the magnetic disk. As a result, difficulty occurs in the existing magnetic head in that the information recording becomes difficult.

As a method to solve the above-described difficulty, a method referred to as a so-called thermally-assisted magnetic recording has been proposed. In this method, a magnetic recording medium having large coercivity is used, and when information is written, heat is applied together with the magnetic field to a section of the magnetic recording medium where the information is to be written to increase the temperature and lower the coercivity of that section, thereby writing the information. Hereinafter, the magnetic head used in the thermally-assisted magnetic recording is referred to as a thermally-assisted magnetic recording head.

In performing the thermally-assisted magnetic recording, near-field light is generally used for applying heat to a magnetic recording medium. For example, in Japanese Unexamined Patent Application Publication No. 2001-255254 and in Japanese Patent No. 4032689, disclosed is a technology of allowing a frequency of light to coincide with a resonant frequency of plasmons that are generated in a metal, by directly applying light to a plasmon generator in order to generate near-field light. In the method of directly applying light to a plasmon generator, however, the plasmon generator itself overheats and accordingly deforms depending on usage environment or conditions, making it difficult to achieve practical realization.

As a technology capable of avoiding such overheating, Japanese Patent No. 4104584 proposes a thermally-assisted head that uses surface plasmon polariton coupling. In this technology, light propagating through a waveguide (guided light) is not directly applied to a plasmon generator, but the guided light is coupled to the plasmon generator through evanescent coupling, and surface plasmon polaritons generated on a surface of the plasmon generator are utilized.

The thermally-assisted magnetic recording head that utilizes the surface plasmon polariton suppresses a rise in temperature of the plasmon generator to some extent. However, it was confirmed that, when Au (gold) is used to configure the plasmon generator for example, there are cases where contraction (agglomeration) resulting from heat occurs especially in a section, near the ABS, where a volume is low and where the heat concentrates.

Such agglomeration is considered to be a phenomenon caused by gold configuring the plasmon generator not being in a stabled state such as a bulk state. That is, since gold formed through a plating method, a sputtering method, or the like is low in density, it is considered that a rise in temperature upon operation of the thermally-assisted magnetic recording head increases the density thereof, and a crystalline structure thereof advances toward a stabilized state. Hence, it is desirable that a heat treatment be performed in advance during manufacturing to stabilize the crystalline structure of a material (such as gold) configuring the plasmon generator.

On the other hand, since the thermally-assisted magnetic recording head is usually provided together with a magnetic reproducing head that includes the MR element, it is desirable that a heat treatment at a temperature that thermally damages operation performance of the MR element be avoided. Therefore, sufficiently stabilizing a crystalline structure of a constituent material of the plasmon generator to sufficiently suppress the agglomeration thereof upon operation is virtually difficult. When such agglomeration occurs, an end section of the plasmon generator is recessed from the ABS and is away from a magnetic recording medium, incurring a decrease in recording performance.

### SUMMARY OF THE INVENTION

For the foregoing reasons, what is desired is a thermally-assisted magnetic recording head capable of suppressing agglomeration of a plasmon generator upon operation and performing higher-density magnetic recording.

A thermally-assisted magnetic recording head according to an embodiment of the invention includes: a waveguide; a magnetic pole; and a plasmon generator having a first region and a second region, in which the first region has an one end exposed on an air-bearing surface and another end located on an opposite side of the air-bearing surface, and in which the second region is coupled to the another end of the first region and has a volume greater than a volume of the first region. The first region includes a high-density region having a density that is greater than the density of the second region.

A head gimbals assembly, a head arm assembly, and a magnetic disk unit according to embodiments of the invention each include the above-described thermally-assisted magnetic recording head.

In the thermally-assisted magnetic recording head, as well as the head gimbals assembly, the head arm assembly, and the magnetic disk unit each including the same according to the embodiments of the invention, the first region including the one end exposed on the air-bearing surface has the high-density region that is higher in density than the second region coupled thereto at the backward section thereof. Thus, even when a rise in temperature in the first region is occurred upon operation, agglomeration (agglomeration) thereof is suppressed. Hence, it is possible to prevent recession of the one end in the first region from the air-bearing surface. On the other hand, because the volume of the first region is smaller than the volume of the second region, it is possible to efficiently generate stronger near-field light in the vicinity of the one end, in the first region, exposed on the air-bearing surface, without increasing incidence energy. As a result, it is possible to perform higher-density magnetic recording efficiently without degrading recording performance.

In the thermally-assisted magnetic recording head, etc., according to an embodiment of the invention, advantageously, the density of the high-density region may be equal to or greater than about 1.1 times the density of the second region. Also, preferably, the high-density region may be located closer to the one end exposed on the air-bearing surface than the another end in the first region. Further, advantageously, a size of the first region in a direction orthogonal to the air-bearing surface may be equal to or less than about 100 nanometers. One reason is that these make it possible to ensure the suppression of the agglomeration in the first region.

A method of manufacturing a thermally-assisted magnetic recording head according to an embodiment of the invention includes: forming a plasmon generator including a first region and a second region, the second region being coupled to the first region and having a volume greater than a volume of the first region; heating the plasmon generator under a vacuum atmosphere or under an inert gas atmosphere, thereby applying a stress to the first region derived from thermal expansion of the second region; and forming, following the heating, an air-bearing surface through polishing a part, located on an opposite side of the second region, of the first region.

In the method of manufacturing the thermally-assisted magnetic recording head according to the embodiment of the invention, the heating is performed before the formation of the air-bearing surface, to apply the stress to the first region from the second region utilizing the thermal expansion of the second region to thereby increase the density of the first region. Thus, even when a rise in temperature in the first region having the one end exposed on the air-bearing surface is occurred upon operation, the agglomeration thereof is suppressed in the thermally-assisted magnetic recording head manufactured through this manufacturing method. Hence, it is possible to prevent the recession of the one end in the first region from the air-bearing surface. On the other hand, the volume of the first region is smaller than the volume of the second region. Thus, it is possible to increase the density of the first region sufficiently even with the heating at a relatively low temperature, and to efficiently generate stronger near-field light in the vicinity of the one end, in the first region, exposed on the air-bearing surface without increasing incidence energy. As a result, it is possible to perform higher-density magnetic recording efficiently without degrading recording performance.

In the method of manufacturing the thermally-assisted magnetic recording head according to an embodiment of the invention, advantageously, the heating may be performed by generating near-field light from the plasmon generator to thereby increase a temperature of the plasmon generator. One reason is that this makes it possible to perform the heat treatment easier and effectively on a section where a rise in temperature is generated significantly upon operation after completion. Also, advantageously, a size of the first region in a direction orthogonal to the air-bearing surface may be made equal to or less than about 100 nm by the polishing. Further, advantageously, a size of the first region removed by the polishing in the direction orthogonal to the air-bearing surface may be made equal to or less than about 100 nm. Moreover, advantageously, a high-density region having a density equal to or greater than about 1.1 times a density of the second region may be formed in the first region by the heating. One reason is that these thus make it possible to ensure the suppression of the agglomeration in the first region. Also, preferably, the plasmon generator may be heated at a temperature from about 200 degrees centigrade to about 250 degrees centigrade both inclusive. One reason is that setting a heating temperature at about 200 degrees centigrade or higher sufficiently improves the density of the first region, and setting the heating temperature at about 250 degrees centigrade or lower prevents adverse effect on other structures, especially on a reproducing element such as a magnetoresistive element, for example.

### BRIEF DESCRIPTION OF THE DRAWINGS

FIG. 1 is a perspective view illustrating a configuration of a magnetic disk unit provided with a magnetic recording reproducing head according to an embodiment of the invention.

FIG. 2 is a perspective view illustrating a configuration of a slider in the magnetic disk unit illustrated in FIG. 1.

FIG. 3 is a sectional view illustrating a structure of a cross-sectional surface (an YZ cross-sectional surface) orthogonal to an air bearing surface in the magnetic recording reproducing head illustrated in FIG. 2.

FIG. 4 is a sectional view illustrating a main part of the magnetic recording reproducing head illustrated in FIG. 3 in an enlarged manner.

FIG. 5 is a schematic diagram illustrating a shape in an XY plane of the main part of the magnetic recording reproducing head.

FIG. 6 is a schematic diagram illustrating a structure of an end surface exposed on the air bearing surface, in the main part of the magnetic recording reproducing head.

FIG. 7 is a perspective view illustrating a process in a method of manufacturing the magnetic disk unit illustrated in FIG. 1.

FIG. 8 is a perspective view illustrating a process subsequent to that of FIG. 7.

FIG. 9 is a sectional view illustrating a process subsequent to that of FIG. 8.

FIG. 10 is a block diagram illustrating a circuit configuration of the magnetic disk unit illustrated in FIG. 1.

FIGS. 11A to 11C are explanatory views illustrating planar shapes of plasmon generators in manufacturing processes of magnetic recording reproducing heads according to an Example and a Comparative Example.

FIG. 12 is a characteristic diagram illustrating a result of a lifetime test according to the Example and the Comparative Example.

### DETAILED DESCRIPTION OF PREFERRED EMBODIMENTS

### Embodiment

Hereinafter, an embodiment of the invention will be described in detail with reference to the drawings.

### [1. Configuration of Magnetic Disk Unit]

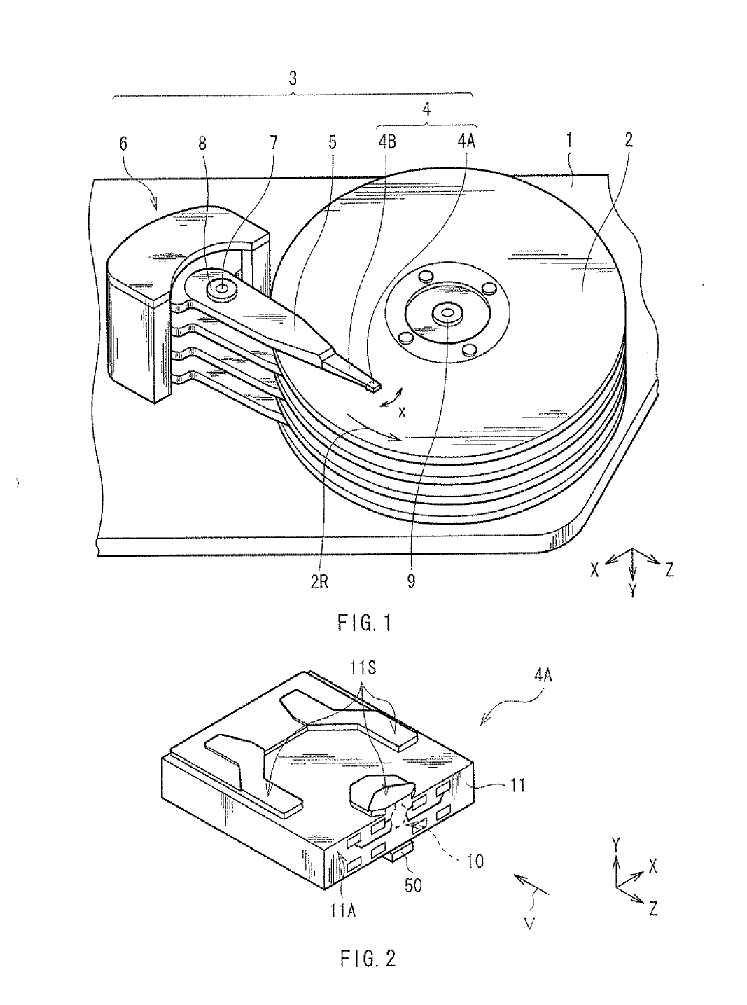

First, referring to FIG. 1 and FIG. 2, a configuration of a magnetic disk unit according to an embodiment of the invention will be described below.

FIG. 1 is a perspective view illustrating an internal configuration of the magnetic disk unit according to the present embodiment. The magnetic disk unit adopts a load-unload (load/unload) scheme as a driving system, and includes, in a housing 1 for example, a magnetic disk 2 as a magnetic recording medium in which information is to be written, and a head arm assembly (HAA) 3 for writing information in the magnetic disk 2 and reading the information therefrom. The HAA 3 includes a head gimbals assembly (HGA)4, an arm 5 supporting a base of the HGA 4, and a driver 6 as a drive power source for allowing the arm 5 to pivot. The HGA 4 includes a thermally-assisted magnetic head device (hereinafter, simply referred to as a “magnetic head device”) 4A having a side surface provided with a magnetic recording reproducing head 10 (described later) according to the present embodiment, and a suspension 4B having an end provided with the magnetic head device 4A. The other end of the suspension 4B (an end opposite to the end provided with the magnetic head device 4A) is supported by the arm 5. The arm 5 is so configured as to be pivotable, through a bearing 8, around a fixed shaft 7 fixed to the housing 1. The driver 6 may be configured of, for example, a voice coil motor. Incidentally, the magnetic disk unit has one or a plurality of (FIG. 1 exemplifies the case of four) magnetic disks 2, and the magnetic head devices 4A are disposed corresponding to recording surfaces (a front surface and a back surface) of the respective magnetic disks 2. Each of the magnetic head devices 4A is movable in a direction across write tracks, that is, in a track width direction (in an X-axis direction) in a plane parallel to the recording surfaces of each of the magnetic disks 2. On the other hand, the magnetic disk 2 rotates around a spindle motor 9 fixed to the housing 1 in a rotation direction 2R substantially orthogonal to the X-axis direction. With the rotation of the magnetic disk 2 and the movement of the magnetic head devices 4A, information is written into the magnetic disk 2 or stored information is read out. Further, the magnetic disk unit has a control circuit (described later) that controls a write operation and a read operation of the magnetic recording reproducing head 10, and an emission operation of a laser diode as a light source that generates laser light used for thermally-assisted magnetic recording described later.

FIG. 2 illustrates a configuration of the magnetic head device 4A illustrated in FIG. 1. The magnetic head device 4A has a block-shaped slider 11 which may be formed of, for example, Al₂O₃.TiC (AlTiC). The slider 11 may be substantially formed as a hexahedron, for example, and one surface thereof corresponds to an ABS 11S that is disposed in proximity to and to face the recording surface of the magnetic disk 2. When the magnetic disk unit is not driven, namely, when the spindle motor 9 is stopped and the magnetic disk 2 does not rotate, the magnetic head device 4A is pulled off to the position away from an above part of the magnetic disk 2 (unload state), in order to prevent contact of the ABS 11S and the recording surface. On the other hand, upon activation, the magnetic disk 2 starts to rotate at a high speed by the spindle motor 9, and the arm 5 is pivotably moved around the fixed shaft 7 by the driver 6, allowing the magnetic head device 4A to move above the front surface of the magnetic disk 2 to be in a load state. The high-speed rotation of the magnetic disk 2 causes an air flow between the recording surface and the ABS 11S, and the resulting lift force leads to a state where the magnetic head device 4A floats to maintain a certain distance (magnetic spacing) in a direction (a Y-axis direction) orthogonal to the recording surface. Also, an element forming surface 11A that is one side surface orthogonal to the ABS 11S is provided with the magnetic recording reproducing head 10. Incidentally, a surface 11B opposite to the ABS 11S of the slider 11 is provided with a light source unit 50 near the magnetic recording reproducing head 10.

### [2. Detailed Structure of Magnetic Recording Reproducing Head]

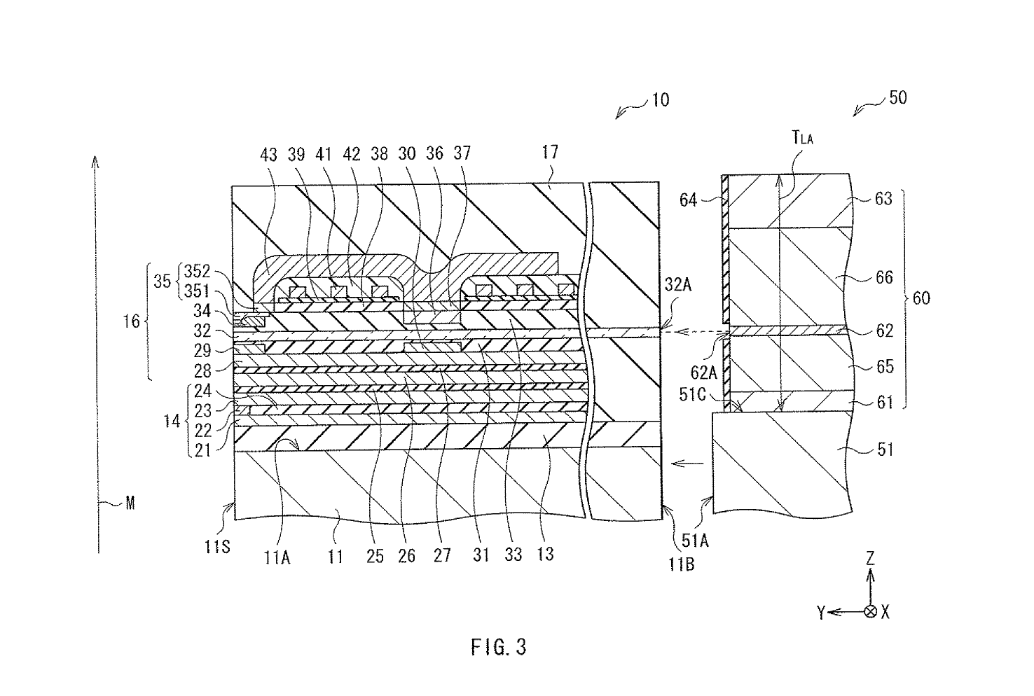

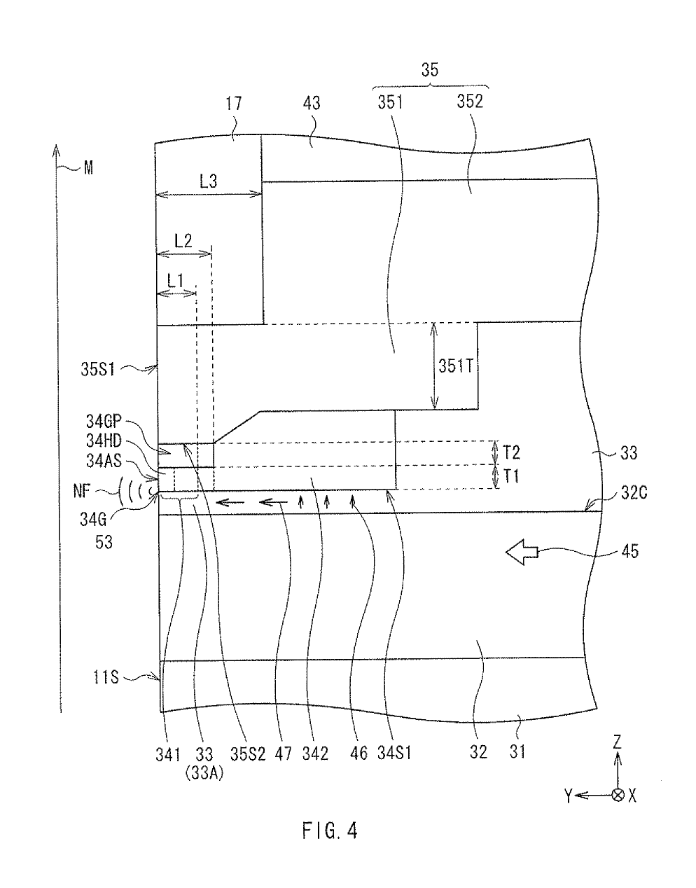

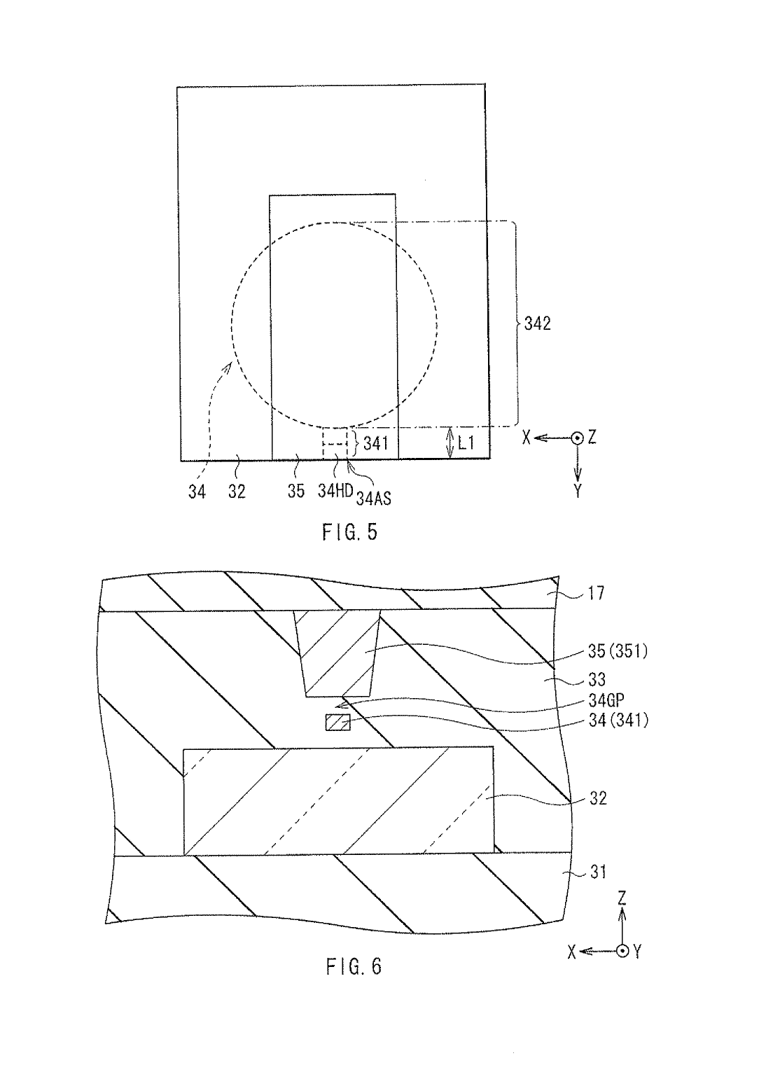

Next, the magnetic recording reproducing head 10 is described in more detail with reference to FIG. 3 to FIG. 6. FIG. 3 is a sectional view of the magnetic recording reproducing head 10 illustrated in FIG. 2 in the Y-Z cross-sectional surface orthogonal to the ABS 11S, and FIG. 4 is an enlarged sectional view of a main part illustrating a part of FIG. 3. FIG. 5 is a schematic diagram illustrating a planar structure of a main part of the magnetic recording reproducing head 10 as viewed from an arrow V direction illustrated in FIG. 2. FIG. 6 illustrates a part of an end surface exposed on the ABS 11S in an enlarged manner. Note that an up-arrow M illustrated in FIG. 3 and FIG. 4 indicates a direction in which the magnetic disk 2 moves relatively with respect to the magnetic recording reproducing head 10.

In the following description, dimensions in the X-axis direction, the Y-axis direction, and the Z-axis direction are referred to as a “width”, a “height” or a “length”, and a “thickness”, respectively, and a closer side and a farther side to/from the ABS 11S in the Y-axis direction are referred to as “front” and “back”, respectively. Moreover, forward and backward in the direction of the arrow M are referred to as a “trailing side” and a “leading side”, respectively, and the X-axis direction and the Z-axis direction are referred to as a “cross track direction” and a “down track direction”, respectively.

The magnetic recording reproducing head 10 has a stacked structure including an insulating layer 13, a reproducing head section 14, a recording head section 16, and a protective layer 17 which are stacked in order on the slider 11. Each of the reproducing head section 14 and the recording head section 16 has an end surface exposed on the ABS 11S.

The reproducing head section 14 uses magneto-resistive effect (MR) to perform a read process. The reproducing head section 14 may be configured by stacking, for example, a lower shield layer 21, an MR element 22, and an upper shield layer 23 in this order on the insulating layer 13.

The lower shield layer 21 and the upper shield layer 23 each may be made of a soft magnetic metal material such as NiFe (nickel iron alloy) for example, and are disposed to face each other with the MR element 22 in between in the stacking direction (in the Z-axis direction). This exhibits a function of protection such that an influence of an unnecessary magnetic field does not reach the MR element 22.

One end surface of the MR element 22 is exposed on the ABS 11S, and the other end surfaces thereof are in contact with an insulating layer 24 that fills a space between the lower shield layer 21 and the upper shield layer 23. The insulating layer 24 is made of an insulating material such as Al₂O₃ (aluminum oxide), AlN (aluminum nitride), SiO₂ (silicon dioxide), and DLC (diamond-like carbon).

The MR element 22 functions as a sensor for reading magnetic information written in the magnetic disk 2. Note that in the present embodiment, in a direction (the Y-axis direction) orthogonal to the ABS 11S, a direction toward the ABS 11S from the MR element 22 or a position near the ABS 11S is referred to as a “forward”, and a direction toward a side opposite to the ABS 11S from the MR element 22 or a position away from the ABS 11S is referred to as a “backward”. The MR element 22 may be, for example, a CPP (Current Perpendicular to Plane)-GMR (Giant Magnetoresistive) element whose sense current flows inside thereof in a stacking direction. The lower shield layer 21 and the upper shield layer 23 each function as an electrode to supply the sense current to the MR element 22.

In the reproducing head section 14 having such a structure, a magnetization direction of a free layer (not illustrated) included in the MR element 22 changes in response to a signal magnetic field from the magnetic disk 2. Thus, the magnetization direction of the free layer shows a change relative to a magnetization direction of a pinned layer (not illustrated) also included in the MR element 22. When the sense current flows through the MR element 22, the relative change in the magnetization directions appears as the change in the electric resistance, and thus, the signal magnetic field is detected with use of the change and the magnetic information is accordingly read out.

An insulating layer 25, an intermediate shield layer 26, and an insulating layer 27 are stacked in order on the reproducing head section 14. The intermediate shield layer 26 functions to prevent a magnetic field generated in the recording head section 16 from reaching the MR element 22, and may be made of, for example, a soft magnetic metal material such as NiFe. The insulating layers 25 and 27 each may be formed of the similar material to that of the insulating layer 24, for example.

The recording head section 16 is a perpendicular magnetic recording head that performs a writing process of thermally-assisted magnetic recording scheme. The recording head section 16 may have, for example, a lower yoke layer 28, a leading shield 29 and a connecting layer 30, a cladding layer 31, a waveguide 32, and a cladding layer 33 in order on the insulating layer 27. Note that a configuration may be employed where the leading shield 29 is omitted.

The lower yoke layer 28, the leading shield 29, and the connecting layer 30 are each made of a soft magnetic metal material such as NiFe. The leading shield 29 is located at a most forward part of the upper surface of the lower yoke layer 28, and is so arranged that one end surface thereof is exposed on the ABS 11S. The connecting layer 30 is located at the backward of the leading shield 29 on the upper surface of the lower yoke layer 28.

The cladding layer 31 is so provided as to cover the lower yoke layer 28, the leading shield 29, and the connecting layer 30.

The waveguide 32 provided on the cladding layer 31 extends in a direction (the Y-axis direction) orthogonal to the ABS 11S. For example, one end surface thereof may be exposed on the ABS 11S, and the other end surface thereof may be exposed at the backward thereof. Note that the forward end surface of the waveguide 32 may be located at a position recessed from the ABS 11S without being exposed on the ABS 11S. The waveguide 32 is formed of a dielectric material that allows laser light to pass therethrough. Specifically, the waveguide 32 may be configured of a material containing essentially one or more of, for example, SiC, DLC, TiOx (titanium oxide), TaOx (tantalum oxide), SiNx (silicon nitride), SiOₓN_{y} (silicon oxynitride), Si (silicon), zinc selenide (ZnSe), NbOx (niobium oxide), GaP (gallium phosphide), ZnS (zinc sulfide), ZnTe (zinc telluride), CrOx (chromium oxide), FeOx (iron oxide), CuOx (copper oxide), SrTiOx (strontium titanate), BaTiOx (barium titanate), Ge (germanium), and C (diamond). Containing essentially means that the above-described materials are contained as main components and other materials may be contained as subcomponents (for example, impurity) as long as a refractive index higher than those of the cladding layers 31 and 33 is provided. The waveguide 32 allows laser light from a laser diode 60 (described later) to propagate toward the ABS 11S. Incidentally, although the cross-sectional shape parallel to the ABS 11S of the waveguide 32 is a rectangular as illustrated in FIG. 6, for example, it may have other shapes.

The cladding layers 31 and 33 are each formed of a dielectric material having a refractive index, with respect to laser light propagating through the waveguide 32, lower than that of the waveguide 32. The cladding layers 31 and 33 each may be configured of a material containing essentially (substantially) one or more of, for example, SiOx (silicon oxide), Al₂O₃ (aluminum oxide), AlN (aluminum nitride), BeO (berylium oxide), SiC (silicon carbide), and DLC (diamond-like carbon). Containing essentially means that the above-described materials are contained as main components and the other materials may be contained as subcomponents (for example, impurity) as long as a refractive index lower than that of the waveguide 32 is provided.

The recording head section 16 further includes a plasmon generator 34 provided above the forward end of the waveguide 32 with the cladding layer 33 in between, and a magnetic pole 35 provided above the plasmon generator 34.

The plasmon generator 34 has a first region 341 and a second region 342 located at the backward thereof. The first region 341 includes one end surface 34AS exposed on the ABS 11S. The second region 342 is coupled to the other end, of the first region 341, located on an opposite side of the ABS 11S, and has a volume greater than a volume of the first region 341.

The first region 341 extends backward over a length L1 from the ABS 11S while maintaining uniform area of a cross section (see FIG. 6) that is parallel to the ABS 11S. The length L1 of the first region 341 may be from 40 nm to 100 nm both inclusive, for example. Also, a thickness T1 of the first region 341 may be from 10 nm to 80 nm both inclusive, for example. Further, the first region 341 includes a high-density region 34HD having a density higher than a density of the second region 342. The density of the high-density region 34HD may preferably be equal to or greater than 1.1 times the density of the second region 342. The high-density region 34HD may be located at a forward section, i.e., near the one end surface 34AS, of the first region 341. In this case, a region other than the high-density region 34HD of the first region 341, i.e., a backward section of the first region 341, may have a density that is lower than the density of the high-density region 34HD and equal to or higher than the density of the second region 342. Alternatively, entire part of the first region 341 may correspond to the high-density region 34HD.

The second region 342 may have a circular planar shape, for example, and has a width larger than a width of the first region 341. A thickness of the second region 342 may be the same as the thickness of the first region 341. However, advantageously, the thickness of the second region 342 may be greater than the thickness of the first region 341 at least in part thereof. One reason is to allow it to function as a heatsink that dissipates heat generated upon operation in the plasmon generator 34.

The first region 341 of the plasmon generator 34 and a first layer 351 (described later) of the magnetic pole 35 are separated away from each other, and a gap 34GP is provided therebetween. The gap 34GP may extend backward over a length L2 from the ABS 11S, for example. The gap 34GP may be filled with the cladding layer 33, for example. It is to be noted that while a case is illustrated in FIG. 4 where the length L2 of the gap 34GP is made greater than the length L1 of the first region 341, it is not limited thereto. For example, the length L1 may be made greater than the length L2, or the length L1 and the length L2 may be made in agreement with one another. The gap 34GP as described above is provided, whereby the first region 341 is surrounded by the cladding layer 33 and is separated away from the forward end of the waveguide 32 and from a forward end in the first layer 351 of the magnetic pole 35. A thickness T2 of the gap 34GP may be from 10 nm to 50 nm both inclusive, for example.

A constituent material of the plasmon generator 34 may be a conductive material containing one or more of a group consisting of, for example, Pd (palladium), Pt (platinum), Rh (rhodium), Ir (iridium), Ru (ruthenium), Au (gold), Ag (silver), Cu (copper), and aluminum (Al). Among these, Au, Ag, and Cu are more preferable, and Au is most preferable, because chemical stability is superior and near-field light NF (described later) is generated more efficiently. Preferably, a constituent material of the first region 341 may be identical to a constituent material of the second region 342. One reason is that this generates the near-field light NF efficiently. This is also for the purpose of preventing complication during manufacturing.

The magnetic pole 35 has a structure in which the first layer 351 and a second layer 352 are stacked in order on the plasmon generator 34. The first layer 351 has an end surface 35S1 exposed on the air bearing surface 11S, and a counter surface 35S2 facing the plasmon generator 34. The second layer 352 extends backward from a position recessed from the ABS 11S by a length L2 (>L1).

Each of the first layer 351 and the second layer 352 may be made of a magnetic material having high saturation flux density such as iron-based alloy, for example. Examples of the iron-based alloy may include FeCo (iron cobalt alloy), FeNi (iron nickel alloy), and FeCoNi (iron cobalt nickel alloy). Incidentally, although a cross-sectional shape of the first layer 351 parallel to the ABS 11S is an inverted trapezoid as illustrated in FIG. 6, for example, it may have other shapes.

The plasmon generator 34 generates the near-field light NF from the ABS 11S, based on the laser light which has propagated through the waveguide 32. The magnetic pole 35 stores therein magnetic flux generated in a coil 41 (described later), and releases the magnetic flux from the ABS 11S to thereby generate a recording magnetic field for recording magnetic information into the magnetic disk 2. The plasmon generator 34 and the first layer 351 are embedded in the cladding layer 33.

The recording head section 16 further includes a connecting layer 36 embedded in the cladding layer 33 at the backward of the plasmon generator 34 and the magnetic pole 35, and a connecting layer 37 so provided as to be in contact with an upper surface of the connecting layer 36, as illustrated in FIG. 3. The connecting layers 36 and 37 are located above the connecting layer 30, and are each made of a soft magnetic metal material such as NiFe. Note that the connecting layer 36 is magnetically connected by a connection section (not illustrated) which may be formed of, for example, a soft magnetic metal material such as NiFe.

As illustrated in FIG. 3, an insulating layer 38 is so provided on the cladding 33 as to fill surroundings of the second layer 352 of the magnetic pole 35. An insulating layer 39 and the coil 41 that is formed in spiral around the connecting layer 37 are stacked in order on the insulating layer 38. The coil 41 generates recording-use magnetic flux by a write current flowing therethrough, and is formed of a high conductive material such as Cu (copper) and Au (gold). The insulating layers 38 and 39 are each made of an insulating material such as Al₂O₃, AlN, SiO₂ and DLC. The insulating layer 38, the insulating layer 39, and the coil 41 are covered with an insulating layer 42. Further, an upper yoke layer 43 is so provided as to cover the insulating layer 42. The insulating layer 42 may be made of, for example, a non-magnetic insulating material that flows at the time of heating, such as a photoresist or a spin-on-glass (SOG). The insulating layers 38, 39, and 42 each electrically separate the coil 41 from its surroundings. The upper yoke layer 43 may be formed of a soft magnetic material having high saturation flux density such as CoFe, the forward section thereof is connected to the second layer 352 of the magnetic pole 35, and a part thereof at a backward section is connected to the connecting layer 37. In addition, the forward end surface of the upper yoke layer 43 is located at a position recessed from the ABS 11S.

In the recording head section 16 having the foregoing structure, the write current flowing through the coil 41 generates a magnetic flux inside a magnetic path that is mainly configured by the leading shield 29, the lower yoke layer 28, the connecting layers 30, 36, and 37, the upper yoke layer 43, and the magnetic pole 35. This generates a signal magnetic field near the end surface of the magnetic pole 35 exposed on the ABS 115, and the signal magnetic field reaches a predetermined region of the recording surface of the magnetic disk 2.

Further, in the magnetic recording reproducing head 10, the protective layer 17 which may be formed of a material similar to that of the cladding layer 33 for example is so formed as to cover the entire upper surface of the recording head section 16. In other words, the cladding layer 33 and the protective layer 17 that are each formed of a material having a lower refractive index compared with the waveguide 32 and high thermal conductivity are so provided as to collectively surround the waveguide 32, the plasmon generator 34, and the magnetic pole 35.

[3. Method of Manufacturing Magnetic Recording Reproducing Head]

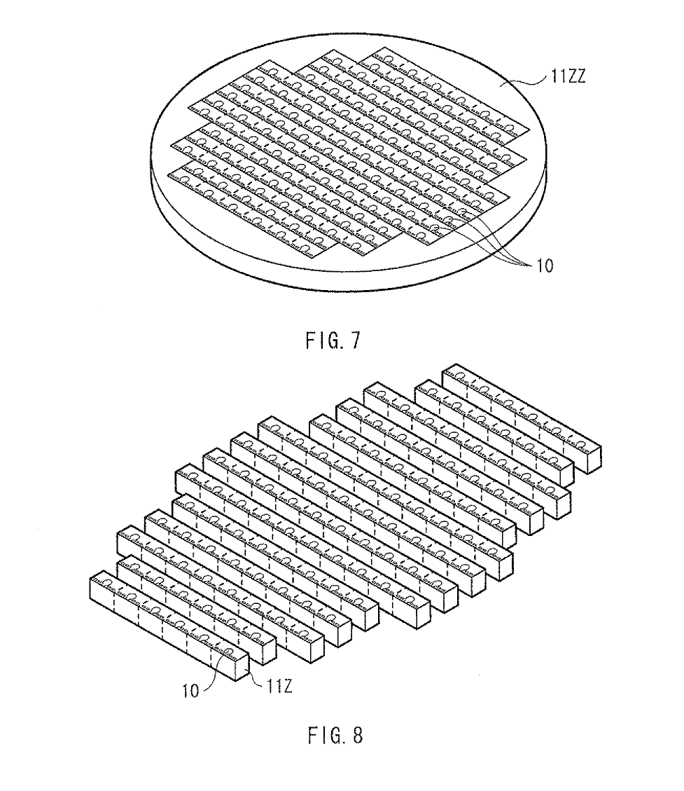

A method of manufacturing the magnetic recording reproducing head 10 will be described with reference to FIGS. 7 to 9 in addition to FIG. 4. FIGS. 7 to 9 are perspective views and a sectional view taken along an YZ plane orthogonal to the ABS 11S each illustrating a process in the method of manufacturing the magnetic recording reproducing head 10.

First, as illustrated in FIG. 7, a wafer 11ZZ which may be made of, for example, AlTiC is prepared. The wafer 11 ZZ serves eventually as a plurality of sliders 11. Thereafter, a plurality of magnetic recording reproducing heads 10 are formed in an array on the wafer 11ZZ as described below.

The magnetic recording reproducing head 10 is manufactured mainly by subsequently forming and stacking a series of components by using an existing thin-film process. Examples of the existing thin-film process may include film-forming technique such as electrolytic plating and sputtering, patterning technique such as photolithography, etching technique such as dry etching and wet etching, and polishing technique such as chemical mechanical polishing (CMP).

Here, first, the insulating layer 13 is formed on the slider 11. Then, the lower shield layer 21, the MR element 22 and the insulating layer 24, and the upper shield layer 23 are formed by stacking in this order on the insulating layer 13 to form the reproducing head section 14. Then, the insulating layer 25, the intermediate shield layer 26, and the insulating layer 27 are stacked in order on the reproducing head section 14.

Thereafter, the lower yoke layer 28, the leading shield 29 and the connecting layer 30, the cladding layer 31, the waveguide 32, the cladding layer 33, the plasmon generator 34, the magnetic pole 35, and the connecting layers 36 and 37 are formed in order on the insulating layer 27. Note that a configuration may be employed where the leading shield 29 is omitted. Further, the insulating layer 38 is so formed as to cover an entire part, following which a planarization process is performed to planarize the upper surfaces of the magnetic pole 35, the insulating layer 38, and the connecting layer 37, followed by forming the coil 41 embedded by the insulating layers 39 and 42. Moreover, the upper yoke layer 43 connected with the magnetic pole 35 and the connecting layer 37 is formed to complete the recording head section 16. Thereafter, the protective layer 17 is formed on the recording head section 16. As a result, the plurality of magnetic recording reproducing heads 10 before the formation of the ABS 11S are formed in an array on the wafer 11ZZ (FIG. 7).

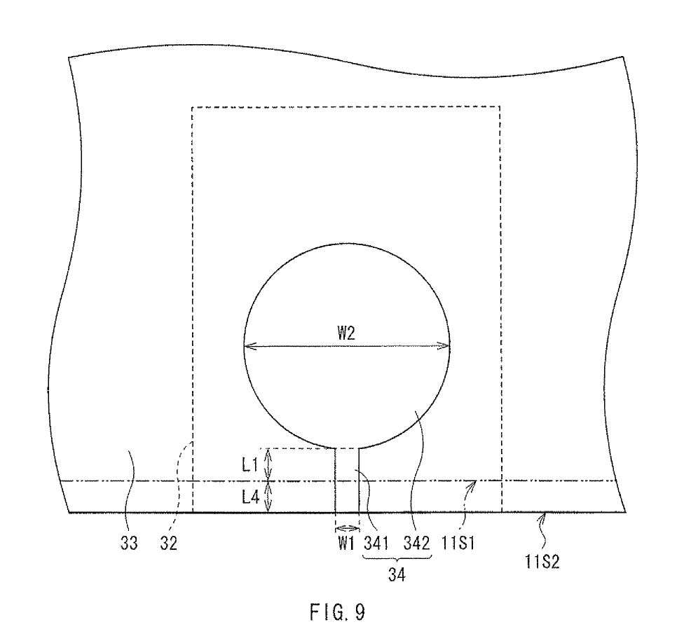

Thereafter, as illustrated in FIG. 8, the wafer 11ZZ is cut to form a plurality of bars 11Z. The plurality of magnetic recording reproducing heads 10 are formed in line in the bars 11Z. It is to be noted that the plasmon generator 34 configured of the first region 341 and the second region 342 that may have the planar shape illustrated in FIG. 9 for example is formed in the bars 11Z. A width W2 which is the maximum in the second region 342 is greater than a width W1 which is the maximum in the first region 341, thereby allowing the volume in the second region 342 to be greater than the volume of the first region 341. The width W1 and the width W2 are each a size corresponding to the track-width direction. In FIG. 9, a two-dot chain line attached with a reference sign 11S1 denotes a position of the ABS 11S formed by a polishing process described later eventually, and a reference sign 11S2 denotes an end surface of the bar 11Z before the polishing process is performed. Incidentally, only the waveguide 32, the cladding layer 33, and the plasmon generator 34 are illustrated in FIG. 9.

After forming the plurality of bars 11Z, these bars 11Z are heated. Specifically, the bars 11Z are heated under a vacuum atmosphere or an inert gas atmosphere to perform heating on the plasmon generator 34 (the first region 341). This causes thermal expansion of the second region 342, thereby applying a stress from the second region 342 to the first region 341 under a high temperature and thus increasing the density of the first region 341. In performing the heating, laser light may be caused to enter the waveguide 32 and the near-field light NF may be generated from the tip section 34G of the first region 341 to increase a temperature of the first region 341. In this heat treatment, preferably, the heating may be so performed as to allow a temperature of the first region 341 to be from about 200 degrees centigrade to about 250 degrees centigrade both inclusive. One reason is that setting the heating temperature at about 200 degrees centigrade or higher sufficiently improves the density of the first region 341, and setting the heating temperature at about 250 degrees centigrade or lower prevents adverse effect on other structures, especially on the MR element 22.

Further, one end surface of the bar 11Z, i.e., a side surface of the stacked structure from the slider 11 up to the protective layer 17, is collectively polished through the CMP method or the like, etc., to form the ABS 11S (FIG. 9). Here, preferably, a length L4 of the first region 341 in a direction orthogonal to the ABS 11S removed by the polishing, i.e., a distance between the end surface 11S2 before the polishing process and the position 11S1 following the polishing process, may be equal to or less than about 100 nm (FIG. 9). Also, the polishing may be so performed as to allow the length L1 of the first region 341 remained thereby to have a predetermined size (for example, about 100 nm or less). The foregoing completes the magnetic recording reproducing head 10.

[4. Detailed Structure of Light Source Unit]

Referring again to FIG. 3, a description is given in detail of the light source unit 50.

The light source unit 50 provided at the backward of the magnetic recording reproducing head 10 includes the laser diode 60 as a light source emitting laser light, and a supporting member 51, which may be rectangular-solid in shape for example, supporting the laser diode 60 as illustrated in FIG. 3.

The supporting member 51 may be formed of, for example, a ceramic material such as Al₂O₃.TiC. As illustrated in FIG. 3, the supporting member 51 includes a bonded surface 51A to be bonded to a back surface 11B of the slider 11, and a light source mounting surface 51C orthogonal to the bonded surface 51A. The light source mounting surface 51C is parallel to the element forming surface 11A. The laser diode 60 is mounted on the light source mounting surface 51C. Desirably, the supporting member 51 may have a function of a heatsink that dissipates heat generated by the laser diode 60, in addition to the function of supporting the laser diode 60.

Those that are generally used for communication, for optical disc storage, or for material analysis, such as InP-based, GaAs-based, and GaN-based ones, can be applied to the laser diode 60. A wavelength of the laser light emitted from the laser diode 60 may have any value within a range of from 375 nm to 1.7 μm, for example. Specifically, an example includes a laser diode of InGaAsP/InP quaternary mixed crystal having the emission wavelength region of from 1.2 to 1.67 gm. As illustrated in FIG. 3, the laser diode 60 has a multilayer structure including a lower electrode 61, an active layer 62, and an upper electrode 63. An n-type semiconductor layer 65, which may include n-type AlGaN for example, is interposed between the lower electrode 61 and the active layer 62, and a p-type semiconductor layer 66, which may include p-type AlGaN for example, is interposed between the active layer 62 and the upper electrode 63. Each of two cleavage surfaces of the multilayer structure is provided with a reflective layer 64 formed of SiO₂, Al₂O₃, or the like for totally reflecting light and exciting oscillation. The reflective layer 64 is provided with an opening for allowing laser light to exit therefrom at a position that includes an emission center 62A of the active layer 62. The relative positions of the light source unit 50 and the magnetic recording reproducing head 10 are fixed, by bonding the bonded surface 51 A of the supporting member 51 to the back surface 11B of the slider 11, in such a manner that the emission center 62A and the back end surface 32A of the waveguide 32 are coincident with each other. The thickness T_{LA} of the laser diode 60 may be, for example, from about 60 to about 200 μm. When a predetermined voltage is applied between the lower electrode 61 and the upper electrode 63, laser light is emitted from the emission center 62A of the active layer 62, which then enters the back end surface 32A of the waveguide 32. Preferably, the laser light emitted from the laser diode 60 may be polarized light of a TM mode whose electric field oscillates in a direction perpendicular to the surface of the active layer 62. The laser diode 60 may be driven with use of a power source in the magnetic disk unit. The magnetic disk unit usually includes a power source that may generate a voltage of about 5 V, for example, and the voltage generated by the power source is sufficient to drive the laser diode 60. In addition, the laser diode 60 may consume power of, for example, about several tens mW, which is sufficiently covered by the power source in the magnetic disk unit.

[5. Control Circuit of Magnetic Disk Unit and Operation]

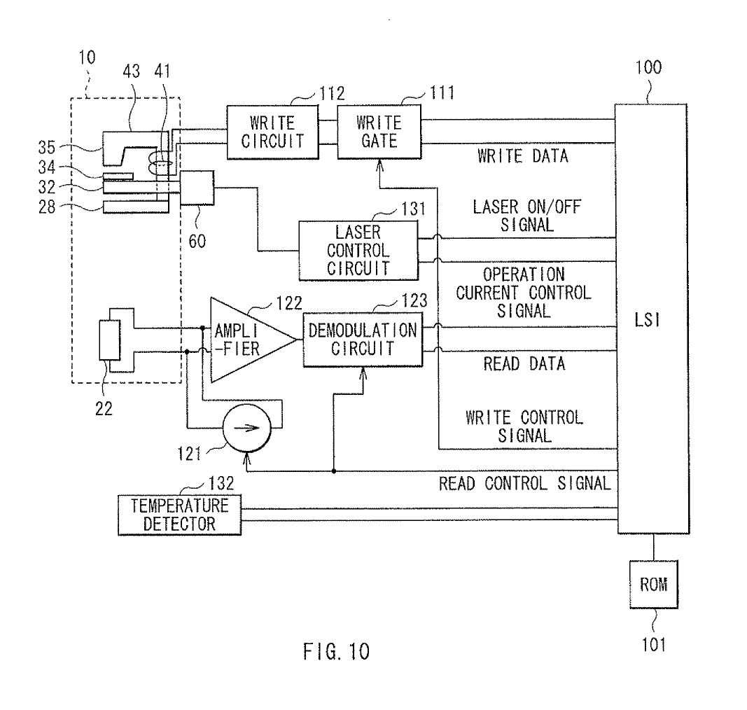

Next, a circuit configuration of a control circuit of the magnetic disk unit illustrated in FIG. 1 and an operation of the magnetic recording reproducing head 10 will be described with reference to FIG. 10. The control circuit includes a control LSI (large-scale integration) 100, a ROM (read only memory) 101 connected to the control LSI 100, a write gate 111 connected to the control LSI 100, and a write circuit 112 that connects the write gate 111 to the coil 41. The control circuit further includes a constant current circuit 121 connected to the MR element 22 and the control LSI 100, an amplifier 122 connected to the MR element 22, and a demodulation circuit 123 connected to an output end of the amplifier 122 and the control LSI 100. The control circuit further includes a laser control circuit 131 connected to the laser diode 60 and the control LSI 100, and a temperature detector 132 connected to the control LSI 100.

Here, the control LSI 100 provides write data and a write control signal to the write gate 111. Moreover, the control LSI 100 provides a read control signal to the constant current circuit 121 and the demodulation circuit 123, and receives read data output from the demodulation circuit 123. In addition, the control LSI 100 provides a laser ON/OFF signal and an operation current control signal to the laser control circuit 131.

The temperature detector 132 detects a temperature of a magnetic recording layer of the magnetic disk 2 to transmit information on the temperature to the control LSI 100.

The ROM 101 stores therein a control table and the like in order to control an operation current value to be supplied to the laser diode 60.

At the time of write operation, the control LSI 100 supplies the write data to the write gate 111. The write gate 111 supplies the write data to the write circuit 112 only when the write control signal instructs to perform the write operation. The write circuit 112 allows the write current to flow through the coil 41 according to the write data. As a result, a recording magnetic field is generated from the magnetic pole 35, and data is written into the magnetic recording layer of the magnetic disk 2 by the recording magnetic field.

At the time of read operation, the constant current circuit 121 supplies a constant sense current to the MR element 22 only when the read control signal instructs to perform the read operation. An output voltage of the MR element 22 is amplified by the amplifier 122, which is then received by the demodulation circuit 123. The demodulation circuit 123 demodulates the output of the amplifier 122 to generate read data to be provided to the control LSI 100 when the read control signal instructs to perform the read operation.

The laser control circuit 131 controls the supply of operation current to the laser diode 60 based on the laser ON/OFF signal, and controls the value of the operation current supplied to the laser diode 60 based on the operation current control signal. The operation current equal to or larger than an oscillation threshold is supplied to the laser diode 60 by the control of the laser control circuit 131 when the laser ON/OFF signal instructs to perform the ON operation. As a result, the laser light is emitted from the laser diode 60 and the laser light propagates through a core 32. Subsequently, the near-field light NF (described later) is generated from the tip section 34G of the plasmon generator 34. By the near-field light NF, a part of the magnetic recording layer of the magnetic disk 2 is heated, and thus the coercivity in that part is lowered. At the time of writing, the recording magnetic field generated from the magnetic pole 35 is applied to the part of the magnetic recording layer where the coercivity is lowered, and thus data recording is performed.

The control LSI 100 determines a value of the operation current of the laser diode 60 with reference to the control table stored in the ROM 101, based on a temperature of the magnetic recording layer of the magnetic disk 2 measured by the temperature detector 132, etc., and controls the laser control circuit 131 with use of the operation current control signal such that the operation current with that value is supplied to the laser diode 60. For example, the control table may include an oscillation threshold of the laser diode 60 and data indicating a temperature dependency of light output-operation current property. The control table may further include data indicating a relationship between the operation current value and an increased amount of the temperature of the magnetic recording layer heated by the near-field light NF, data indicating a temperature dependency of the coercivity of the magnetic recording layer, and the like.

The control circuit illustrated in FIG. 10 has a signal system for controlling the laser diode 60, that is, a signal system of the laser ON/OFF signal and the operation current control signal, independent of the control signal system of write-read operation, thereby achieving not only the conduction to the laser diode 60 simply operated in conjunction with the write operation, but also more various modes of conduction to the laser diode 60. Note that the configuration of the control circuit of the magnetic disk unit is not limited to that illustrated in FIG. 10.

Next, a principle of near-field light generation and a principle of thermally-assisted magnetic recording with use of the near-field light according to the present embodiment will be described with reference to FIG. 4.

Laser light 45 emitted from the laser diode 60 propagates through the waveguide 32 to reach the neighborhood of the plasmon generator 34. At this time, the laser light 45 is totally reflected by an evanescent light generating surface 32C that is an interface between the waveguide 32 and a buffer section 33A (a section between the waveguide 32 and the plasmon generator 34, of the cladding layer 33), thereby generating evanescent light 46 that leaks into the buffer section 33A. Thereafter, the evanescent light 46 couples with charge fluctuation, on a surface plasmon exciting surface 34S 1 that faces the waveguide 32 of the plasmon generator 34, to induce a surface plasmon polariton mode. As a result, surface plasmons 47 are excited on the surface plasmon exciting surface 34S 1. The surface plasmons 47 propagate on the surface plasmon exciting surface 34S1 toward the ABS 11S.

The surface plasmons 47 eventually reach the ABS 11S, and as a result, the near-field light NF is generated on the tip section 34G. The near-field light NF is radiated toward the magnetic disk 2 (not illustrated in FIG. 4) and reaches the surface of the magnetic disk 2 to heat a part of the magnetic recording layer of the magnetic disk 2, thereby lowering the coercivity of the heated part of the magnetic recording layer. In the thermally-assisted magnetic recording, data writing is performed by applying the recording magnetic field generated by the magnetic pole 35 to a part of the magnetic recording layer where the coercivity is thus lowered.

[6. Effects]

According to the magnetic recording reproducing head 10 of the present embodiment, the first region 341 including the one end surface exposed on the ABS 11S has the high-density region 34HD that is higher in density than the second region 342 coupled thereto at the backward section thereof, as described above. Thus, the agglomeration of the first region 341 is suppressed even when a rise in temperature in the first region 341 is occurred upon operation. Hence, it is possible to prevent recession of the one end surface 34AS from the ABS 11S. On the other hand, because the volume of the first region 341 is smaller than the volume of the second region 342, it is possible to efficiently generate the stronger near-field light NF in the vicinity of the one end surface 34AS without increasing incidence energy on the waveguide 32. As a result, it is possible to perform higher-density magnetic recording efficiently without degrading recording performance.

Also, in the method of manufacturing the magnetic recording reproducing head 10 according to the present embodiment, the heat treatment is performed before the formation of the ABS 11S, to apply a stress to the first region 341 derived from the thermal expansion of the second region 342 under a high temperature to thereby increase the density of the first region 341. Thus, in the magnetic recording reproducing head 10 manufactured through this manufacturing method, the agglomeration of the first region 341 is suppressed even when a rise in temperature in the first region 341 including the one end surface 34AS exposed on the ABS 11S is occurred upon operation thereof. Hence, it is possible to prevent recession of the one end surface 34AS from the ABS 11S. On the other hand, the volume of the first region 341 is made smaller than the volume of the second region 342. Thus, it is possible to increase the density of the first region 341 sufficiently even with the heat treatment at a relatively low temperature, and to efficiently generate the stronger near-field light NF in the vicinity of the one end surface 34AS without increasing incidence energy on the waveguide 32. As a result, it is possible to perform higher-density magnetic recording efficiently without degrading recording performance.

Further, allowing the configuration to satisfy at least one of the following requirements in the present embodiment makes it possible to ensure the suppression of the agglomeration in the first region 341. Specifically, first, the density of the high-density region 34HD may be made equal to or greater than 1.1 times the density of the second region 342, second, the high-density region may be located, in the first region 341, closer to the one end surface 34AS than the other end coupled to the second region 342, and third, the length L1 of the first region 341 in the direction orthogonal to the ABS 11S may be made equal to or less than about 100 nm.

### EXAMPLES

Examples of the invention will be described in detail.

### 1. Lifetime Test (1)

### Experiment 1

### Samples 1-1 to 1-6

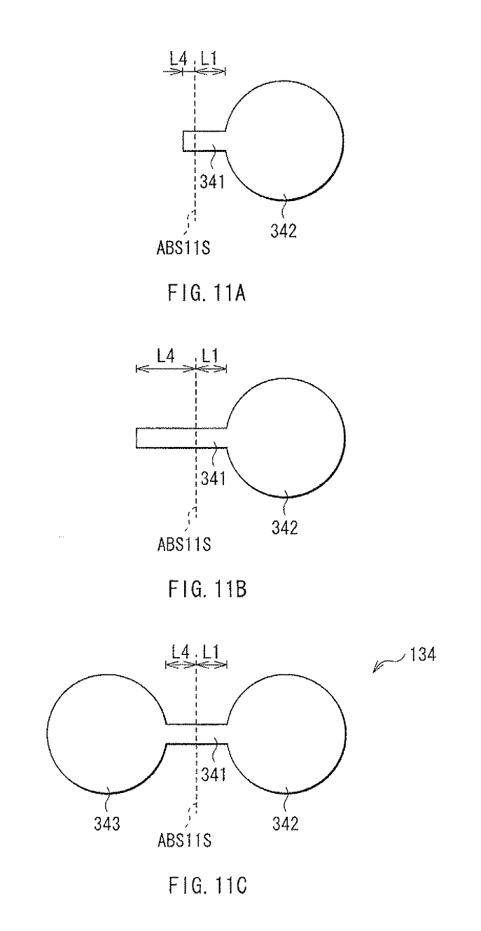

A test on lifetime was conducted, at the following conditions, on the magnetic recording reproducing head 10 of the invention, obtained through subjecting the plasmon generator 34 in which the length L1 and the length L4 were both 100 nm to a heat treatment and polishing the same, as illustrated in FIG. 11A. Specifically, heat with power equivalent to 2.5 times as much as that used in an actual write operation was applied to the magnetic recording reproducing head 10, following which writing of information was performed with the power used in the actual write operation, to measure the time taken for a signal-to-noise ratio (SNR) of a read signal to cause a 2 dB decrease for an initial value. Also, the plasmon generator 34 was entirely formed by Au, and a temperature of 220 degrees centigrade was maintained for two hours in the heat treatment.

### Experiment 2

### Samples 2-1 to 2-6

A test on lifetime was conducted, at conditions similar to those described above, on the magnetic recording reproducing head 10 of the invention, obtained through subjecting the plasmon generator 34 in which the length L1 was 100 nm and the length L4 was 300 nm to the heat treatment and polishing the same, as illustrated in FIG. 11B.

### Experiment 3

### Samples 3-1 to 3-6

As a Comparative Example, a similar lifetime test was performed also on a magnetic recording reproducing head, which was obtained in a similar way to the Experiment 1 except that a plasmon generator 134, in which a third region 342 was provided on an opposite side of the second region 342 with the first region 341 interposed in between, was fabricated, as illustrated in FIG. 11C.

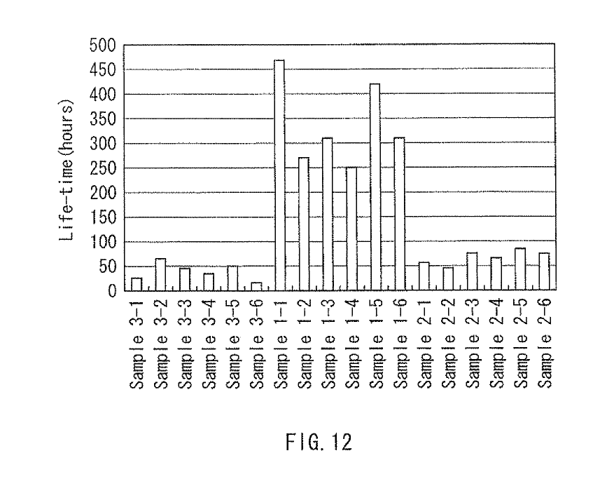

FIG. 12 shows a result of the lifetime tests. As shown in FIG. 12, an improvement in lifetime was confirmed in the Experiments 1 and 2 corresponding to the invention as compared with the Experiment 3 as the Comparative Example. In particular, a significant improvement in lifetime was confirmed in the Experiment 1 (the samples 1-1 to 1-6).

An analysis on density performed on each of the samples utilizing an electron diffraction method confirmed that a density near an end section in the first region 341 was equal to or greater than 1.1 times a density of other region in the Experiment 1. In the Experiment 2, it was confirmed that the density near the end section in the first region 341 was greater than the density of other region by about few percent. In contrast, in the Experiment 3, a difference between the density of the first region 341 and the density of the second region 342 was hardly confirmed. Therefore, the higher density of the first region 341 as compared with the density of the second region 342 in the plasmon generator 34 presumably provides the longer lifetime of the magnetic recording reproducing head 10.

Incidentally, the density analysis utilizing the electron diffraction method includes a Convergent-Beam Electron Diffraction (CBED) method, an Electron Energy-Loss Spectroscopy (EELS) method, or the like. The convergent-beam electron diffraction method, the electron energy-loss spectroscopy method, or the like makes it possible to measure a density of a micro region when a sample thickness of an observation area is precisely defined.

### 2. Lifetime Test (2)

### Experiments 4-1 to 4-5

Next, a relationship between the length L4 and lifetime was examined. Here, a lifetime test was performed on those that were fabricated in a similar way to those according to the Experiment 1 except that the length L4 of the region removed by the polishing process was varied, and was performed at conditions similar thereto. Table 1 shows a result thereof, where each of the Experiments 4-1 to 4-5 represents a mean value of six samples in the Table 1.

TABLE 1

| Sample | L4 (nm) | Lifetime (h) |
|---|---|---|
| 4-1 | 20 | 374 |
| 4-2 | 50 | 382 |
| 4-3 | 70 | 352 |
| 4-4 | 100 | 338 |
| 4-5 | 150 | 124 |

As shown in the Table 1, it was found that allowing the length L4, i.e., the length of the region removed by the polishing process, to be 10 nm or less makes it possible to achieve longer lifetime. One reason is that the density in the end section of the first region 341 following the polishing process depends on the length L4. Incidentally, it was also confirmed that allowing the length L1 to be short increases slightly the density in the end section of the first region 341 following the polishing process. However, it was also found that the density thereof is controlled stronger by the length L4 than by the length L1.

While the invention has been described with reference to an embodiment, the invention is not limited to the foregoing embodiment and various modifications may be made. For example, the thermally-assisted magnetic recording head of the invention is not limited to that described in the foregoing embodiment in configurations (such as shapes and positional relationships) of the waveguide, the plasmon generator, the magnetic pole, etc., and the thermally-assisted magnetic recording head may have any other configuration.

Correspondence relationships between the reference numerals and the components in the present embodiment are collectively illustrated as follows. 1 . . . housing, 2 . . . magnetic disc, 3 . . . head arm assembly (HAA), 4 . . . head gimbals assembly (HGA), 4A . . . magnetic head device, 4B . . . suspension, 5 . . . arm, 6 . . . driver, 7 . . . fixed shaft, 8 . . . bearing, 9 . . . spindle motor, 10 . . . magnetic recording reproducing head, 11 . . . slider, 11A . . . element forming surface, 11B . . . back surface, 11S . . . air bearing surface (ABS), 12 . . . element forming layer, 13 . . . insulating layer, 14 . . . reproducing head section, 16 . . . recording head section, 17 . . . protective layer, 21 . . . lower shield layer, 22 . . . MR element, 23 . . . upper shield layer, 24, 25, 27, 38, 39, 42 . . . insulating layer, 26 . . . intermediate shield layer, 28 . . . lower yoke layer, 29 . . . leading shield, 30, 36, 37 . . . connecting layer, 31, 33 . . . cladding layer, 32 . . . waveguide, 34 . . . plasmon generator, 34HD . . . high-density region, 341 . . . first region, 342 . . . second region, 34G . . . tip section, 34S1 . . . surface plasmon exciting surface, 35 . . . magnetic pole, 351 . . . first layer, 352 . . . second layer, 41 . . . coil, 43 . . . upper yoke layer, 45 . . . laser light, 46 . . . evanescent light, 47 . . . surface plasmon, 100 . . . LSI, 101 . . . ROM, 111 . . . write gate, 121 . . . constant current circuit, 122 . . . amplifier, 123 . . . demodulation circuit, 131 . . . laser control circuit, 132 . . . temperature detector, NF . . . near-field light.

What is claimed is:

1. A thermally-assisted magnetic recording head, comprising:
a waveguide;
a magnetic pole; and
a plasmon generator having a first region and a second region, the first region having an one end exposed on an air-bearing surface and another end located on an opposite side of the air-bearing surface, the second region being coupled to the another end of the first region and having a volume greater than a volume of the first region, and the first region including a high-density region having a density that is greater than the density of the second region.

2. The thermally-assisted magnetic recording head according to claim 1, wherein the density of the high-density region is equal to or greater than about 1.1 times the density of the second region.

3. The thermally-assisted magnetic recording head according to claim 1, wherein the high-density region is located closer to the one end than the another end in the first region.

4. The thermally-assisted magnetic recording head according to claim 3, wherein a region other than the high-density region in the first region has a density that is less than the density of the high-density region and equal to or greater than the density of the second region.

5. The thermally-assisted magnetic recording head according to claim 1, wherein a size of the first region in a direction orthogonal to the air-bearing surface is equal to or less than about 100 nanometers.

6. The thermally-assisted magnetic recording head according to claim 1, wherein a thickness of the first region is substantially same as or less than a thickness of the second region.

7. The thermally-assisted magnetic recording head according to claim 1, wherein a width in a track-width direction of the second region is greater than a width in the track-width direction of the first region.

8. The thermally-assisted magnetic recording head according to claim 1, wherein the first region is formed of a material that is same as a material of the second region.

9. The thermally-assisted magnetic recording head according to claim 8, wherein each of the first region and the second region is configured essentially of one or more elements selected from a group consisting of Au (gold), Ag (silver), and Cu (copper).

10. The thermally-assisted magnetic recording head according to claim 1, wherein
the plasmon generator is provided between the waveguide and the magnetic pole,
the magnetic pole includes an one end exposed on the air-bearing surface, and
the one end of the magnetic pole and the one end of the first region are separated away from each other.

11. The thermally-assisted magnetic recording head according to claim 1, wherein the first region extends in a direction orthogonal to the air-bearing surface while maintaining uniform cross-sectional area parallel to the air-bearing surface.

12. A head gimbals assembly, comprising:
a magnetic head slider having a side surface, the side surface including the thermally-assisted magnetic recording head according to claim 1; and
a suspension having an end, the end being attached with the magnetic head slider.

13. A head arm assembly, comprising:
a magnetic head slider having a side surface, the side surface including the thermally-assisted magnetic recording head according to claim 1;
a suspension having a first end and a second end, the first end being attached with the magnetic head slider; and
an arm supporting the suspension at the second end thereof.

14. A magnetic disk unit provided with a magnetic recording medium and a head arm assembly, the head arm assembly comprising:
a magnetic head slider having a side surface, the side surface including the thermally-assisted magnetic recording head according to claim 1;
a suspension having a first end and a second end, the first end being attached with the magnetic head slider; and
an arm supporting the suspension at the second end thereof.

15. A method of manufacturing a thermally-assisted magnetic recording head, the method comprising:
forming a plasmon generator including a first region and a second region, the second region being coupled to the first region and having a volume greater than a volume of the first region;
heating the plasmon generator under a vacuum atmosphere or under an inert gas atmosphere, thereby applying a stress to the first region derived from thermal expansion of the second region under a high temperature; and
forming, following the heating, an air-bearing surface through polishing a part, located on an opposite side of the second region, of the first region.

16. The method of manufacturing the thermally-assisted magnetic recording head according to claim 15, wherein the heating is performed by generating near-field light from the plasmon generator to thereby increase a temperature of the plasmon generator.

17. The method of manufacturing the thermally-assisted magnetic recording head according to claim 15, wherein the first region is formed using a material that is same as a material that forms the second region.

18. The method of manufacturing the thermally-assisted magnetic recording head according to claim 17, wherein each of the first region and the second region is formed using essentially one or more elements selected from a group consisting of Au (gold), Ag (silver), and Cu (copper).

19. The method of manufacturing the thermally-assisted magnetic recording head according to claim 15, wherein the heating of the plasmon generator is performed at a temperature from about 200 degrees centigrade to about 250 degrees centigrade both inclusive.
